(19) United States
(12) Patent Application Publication
(10) Pub. No.: US 2014/0359463 A1
(43) Pub. Date: Dec. 4, 2014

(54) DATA TEMPLATES FOR DEFAULT DATA IN DATA BINDING

(71) Applicant: Martin Schaus, Karlsruhe (DE)

(72) Inventor: Martin Schaus, Karlsruhe (DE)

(73) Assignee: SAP AG, Walldorf (DE)

(21) Appl. No.: 13/908,569

(22) Filed: Jun. 3, 2013

(51) Int. Cl. G06F 3/0484

(52) U.S. Cl. CPC G06F 3/0484
USPC 715/738

(57) ABSTRACT

The present disclosure involves methods and devices, including computer programs encoded on a computer storage medium, for providing a remote update of a user interface on a computing device. In one aspect, a server performs the operations of: providing a data template to a remote computing device, wherein the data template defines multiple data cells that are bound to a graphical user interface at the remote computing device, and wherein each data cell is associated with a current data element; receiving multiple second data elements each corresponding to one of the multiple data cells of the data template; determining that one or more of the second data elements are different from the current data elements of the corresponding data cells of the data template; and transmitting the one or more second data elements that are different from the current data elements of the corresponding data cells of the data template to the remote computing device for associating the transmitted one or more second data elements with the corresponding data cells of the data template.

### TECHNICAL FIELD

The present disclosure relates to a remote computing device for information workers that provides multiple operating modes with associated functions.

### BACKGROUND

Computing devices are increasingly employed by users for private and business applications. An information or knowledge worker may use several communication devices for daily work, such as a cell phone, a smartphone, a tablet PC, a laptop, a personal computer, a netbook, a personal digital assistant, an e-book reader, a database system and/or other computing devices. Each of the computing devices may be used for a specific purpose or application and usually comprise a user interface which enable the user to interact with the computing device. These computing devices possess different sizes of displays and data processing capabilities depending on their application. The variety of computing devices and their utilization in daily life are thereby quickly expanding.

### SUMMARY

The present disclosure describes one or more general aspects involving a remote computing device for information workers that provides multiple operating modes with associated functions.

One or more of the following aspects of this disclosure can be embodied as methods that include the corresponding operations. One or more of the following aspects of this disclosure can be implemented in a device comprising a processor, a computer-readable medium coupled to the processor having instructions stored thereon which, when executed by the processor, cause the processor to perform operations according to the one or more of the following aspects. One or more of the following aspects of this disclosure can be implemented on a computer-readable medium having instructions stored thereon that, when executed by a processor, cause the processor to perform operations according to the one or more of the following aspects.

In a general aspect 1 of this disclosure comprises providing a data template to a remote computing device, wherein the data template defines multiple data cells that are bound to a user interface (e.g., a graphical user interface such as a browser user interface) at the remote computing device, and wherein each data cell is associated with a current data element (e.g., default data elements such as values, signs, alphanumeric characters, hypertext markup language code, uniform resource locators, or similar indicators that are processable by a computing device as understood herein); receiving multiple second data elements each corresponding to one of the multiple data cells of the data template; determining that one or more of the second data elements are different from the current data elements of the corresponding data cells of the data template; and transmitting the one or more second data elements that are different from the current data elements of the corresponding data cells of the data template to the remote computing device for associating the transmitted one or more second data elements with the corresponding data cells of the data template.

Aspect 2 according to aspect 1, wherein the one or more second data cells are transmitted to the computing device without transmitting to the computing device data elements of the multiple second data elements that are not different from the current data elements of the corresponding data cells of the data template.

Aspect 3 according to any one of aspects 1 to 2, wherein the associating of the transmitted one or more second data elements with the corresponding data cells of the data template comprises: binding the transmitted one or more second data elements to the user interface; and updating the user interface.

Aspect 4 according to any one of aspects 1 to 3, wherein the data template is a table comprising the multiple data cells and their associated data elements, and optionally wherein the data elements are stored in the associated data cells of the data template.

Aspect 5 according to any one of aspects 1 to 4, wherein the data elements define control parameters of icons of the user interface, wherein the control parameters are configured to create, modify, or delete corresponding one or more icons of the user interface.

Aspect 6 according to any one of aspects 1 to 5, wherein the associating of the one or more second data elements with the corresponding data cells of the data template initiates a creation, a modification, or a deletion of the one or more icons of the user interface that are bound to the corresponding data cells with which the transmitted one or more second data elements are associated.

Aspect 7 according to any one of aspects 1 to 6, further comprising: receiving, at the remote computing device, the data template and binding the current data elements to one or more icons of the user interface at the remote computing device, wherein the current data elements define control parameters of the one or more icons of the user interface, and wherein the control parameters are configured to create, modify, or delete corresponding one or more icons of the user interface;

Aspect 8 according to any one of aspects 1 to 7, further comprising: associating, by the remote computing device, the transmitted one or more second data elements with the corresponding data cells of the data template, wherein the associating of the one or more second data elements with the corresponding data cells of the data template initiates a creation, a modification, or a deletion of one or more icons of the user interface that are bound to the corresponding data cells with which the transmitted one or more second data elements are associated.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 illustrates an example operating environment for implementing various aspects providing an update of a user interface on a remote computing device.

FIG. 2 illustrates a comparison of exemplary model data without 201 and with 202 using a data template.

FIG. 3 illustrates a comparison of an exemplary update of an entire data grid without and with using the data template.

FIG. 4 illustrates an exemplary process or method for updating a user interface at a remote computing device.

Reference numbers and designations in the various drawings indicate exemplary aspects, implementations or embodiments of particular features of the present disclosure.

### DETAILED DESCRIPTION

This disclosure generally relates to a system, method and computing device to update a user interface on a remote computing device. Specifically, tools and methods for providing an update of a graphical user interface, such as a browser user interface, on a remote computing device.

The subject-matter described in this disclosure can be implemented in particular embodiments so as to realize one or more of the following advantages.

First, certain aspects can allow a remote control of a user interface of the remote computing device.

Second, only data that differs from the current data associated to the user interface is transmitted while only transmitting the minimum required amount of data for the updating the user interface. This may reduce the processing load of the remote computing device and/or the network infrastructure.

Third, the amount of memory needed at the remote computing device is reduced.

Fourth, an update of a user interface is made more efficient thereby reducing the total amount of time required to implement the update of the user interface at the remote computing device.

Fifth, the total cost of ownership may be reduced.

Sixth, data of a highly repetitious character can be optimized for easier modifications, including for lists and tree-based data.

An information or knowledge worker may use several communication devices for daily work, such as a cell phone, a smart phone, a tablet PC, a laptop, a personal computer, a netbook, a personal digital assistant, an e-book reader, a database server and/or other computing devices. Each of the computing devices may be used for a specific purpose or application. For example, a cell phone may be used for conventional phone calls and a smartphone may be used for app- and browser-based communication, such as social networking or electronic messengers. For example, tablet PCs may be used in circumstances when a laptop is too heavy or too large, e.g. at meetings and for organizing schedules on one's way. For example, laptops may be used for editing larger electronic documents nearby the workplace. A database server may be used to search for large amounts of data and retrieve the search results for further processing. Each device may provide a certain limit of the amount of data that can be displayed on its display screen. Furthermore, each type of device may have certain limits regarding processing speed or processing load it can handle during use. Some devices may only have a limited amount of network connectivity for communication with a central server. This raises a need for an efficient, remote and device-adapted update of user interfaces at computing devices.

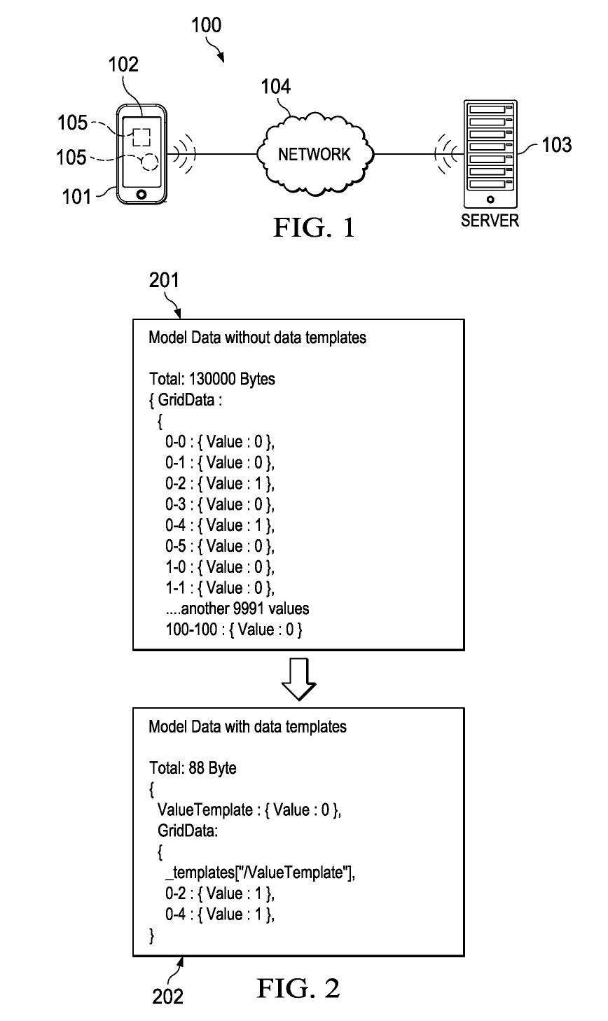

FIG. 1 illustrates an example operating environment 100 for implementing various aspects of providing an updated graphical user interface (e.g., a browser user interface) to a remote computing device 101 (e.g., a personal computer, a database, or a mobile communication device). Operating environment 100 may include a server 103 and one or more networks 104, such as the Internet, public telephone network, a cellular network, a satellite network, a wireless local area network, a short-range connection network and/or the like. Remote computing device 101 as described herein may provide a graphical user interface 102 for display on a display screen. The graphical user interface 102 may be a graphical user interface that comprises one or more icons 105 that provide multiple functions, such as: input/out for parameter values, controlling (e.g., initiating, adjusting or ending) an electronic process inside or outside of the remote computing device (e.g., the icons 105 may control an electronic process at another computing device or at an industrial machine), sending or receiving emails or phone calls, or displaying measures such as a current status of the electronic process inside or outside the remote computing device. Remote computing device 101 may operate within operating environment 100 using one or more of the hardware and/or software described herein. Remote computing device 101 may be a handheld device, such as a cell phone.

In one or more aspects, remote computing device 101 may communicate with server 103 via a wireless and/or wired network connection 104 in one or more operating modes for the remote computing device 101. For example, server 103 may connect to and/or communicate with remote computing device 101 via a wired network connection or via a wireless network connection (e.g., a cellular network connection) 104. Server 103 may also connect to and/or communicate with the graphical user interface 102 of the remote computing device 101 in one or more operating modes of the device 101 via the network 104 to enable the remote computing device 101 (e.g., via the graphical user interface) to access a wide area network, such as the Internet. For example, remote computing device 101 may receive and send data via the Internet 104 and display web content via its browser user interface 102.

FIG. 2 illustrates a comparison of exemplary model data without 201 and with 202 using a data template. While using a data model on the remote computing device 101 to bind data to the user interface it is currently necessary to send all data nodes that are bound to user interface elements (such as icons 105). For data lists this may result in a lot of data nodes and a lot of bytes that need to be sent to the remote computing device 101. By using a data template as a default for all data list entries one may reduce the amount of data dramatically. The server 103 of the operating environment 100 for providing an updated graphical user interface to a remote computing device 101 may comprise: a processor; a computer-readable storage medium coupled to the processor having instructions stored thereon which, when executed by the processor, cause the processor to perform operations comprising: providing a data template to the remote computing device 101, wherein the data template defines multiple data cells that are bound to a graphical user interface 102, and wherein each data cell is associated with a current data element; receiving multiple second data elements each corresponding to one of the multiple data cells of the data template; determining that one or more of the second data elements are different from the current data elements of the corresponding data cells of the data template; transmitting the one or more second data elements that are different from the current data elements of the corresponding data cells of the data template to the remote computing device 101 for associating the transmitted one or more second data elements with the corresponding data cells of the data template.

In an aspect, one or more second data cells are transmitted to the computing device 101 without transmitting to the computing device data elements of the multiple second data elements that are not different from the current data elements of the corresponding data cells of the data template. For example, view graph 201 shows multiple data cells “0-0”, “0-1”, . . . “100-100” which are associated with certain data elements, which in this examples are values “0” and “1”. Initially, all values may be set to “0”. View graph 202 shows that by using the data template “ValueTemplate”, only the second data elements that are different from the current data elements are transmitted to the remote computing device 101. In this example, only the data elements associated to the data cells “0-2” and “0-4” are transmitted to the remote computing device 101, while the other data cells remain unchanged in the data template. In this example of FIG. 2, the total amount of data elements transmitted to the remote computing device is reduced from 130000 Bytes, at the situation where no data template is used, down to 88 Byte through using the data template.

In an aspect, the server receives an information from the remote computing device which indicates how much data can be displayed on the display screen of the remote computing device and the transmitted one or more second data elements is the below the maximum amount of data that can be displayed on the display screen of the remote computing device. In an aspect, only the second data elements are transmitted to the remote computing device which can still be displayed by the remote computing device, e.g. by the user interface at the remote computing device. In an aspect, the associating of the transmitted one or more second data elements with the corresponding data cells of the data template comprises: binding the transmitted one or more second data elements to the graphical user interface 102; and updating the graphical user interface 102. In an aspect, the data template is a table comprising the multiple data cells and their associated data elements. In an aspect, the data elements are stored in the associated data cells of the data template. In general, data cells may be activated/deactivated for usage of the user interface 102 by associating the transmitted one or more second data elements with the activated/deactivated data cells of the data template.

In an implementation, the data elements define control parameters of icons 105 of the graphical user interface 102, wherein the control parameters are configured to create, launch, modify, update or delete corresponding one or more icons 105 of the graphical user interface 102. In an aspect, the associating of the one or more second data elements with the corresponding data cells of the data template initiates a creation, a launch, a modification, an update or a deletion of the one or more icons 105 of the graphical user interface 102 that are bound to the corresponding data cells with which the transmitted one or more second data elements are associated. For example, upon receiving the transmitted one or more second data elements, the graphical user interface of the remote computing device 101 is updated by creating, launching, modifying, updating, or deleting the one or more icons 105 of the user interface. This may provide a remote control of the user interface of the computing device while only transmitting the minimum required amount of data for the updating of the user interface 102. Only the data nodes that differ from the default value are sent to the client, as illustrated in FIG. 2. The amount of data sent may be reduced to the required, thereby reducing the processing load of the remote computing device and/or the network 104.

In an aspect, the remote computing device 101 may communicate with the server 103 via network 104 and may comprise: a processor; a computer-readable storage medium coupled to the processor having instructions stored thereon which, when executed by the processor, cause the processor to perform operations comprising: receiving the data template and binding the current data elements to one or more icons 105 of the graphical user interface 102 at the remote computing device 101, wherein the current data elements define control parameters of the one or more icons 105 of the graphical user interface 102, and wherein the control parameters are configured to create, launch, modify, update or delete corresponding one or more icons 105 of the graphical user interface 102; associating the transmitted one or more second data elements with the corresponding data cells of the data template, wherein the associating of the one or more second data elements with the corresponding data cells of the data template initiates a creation, a launch, a modification, an update or a deletion of one or more icons 105 of the graphical user interface 102 that are bound to the corresponding data cells with which the transmitted one or more second data elements are associated.

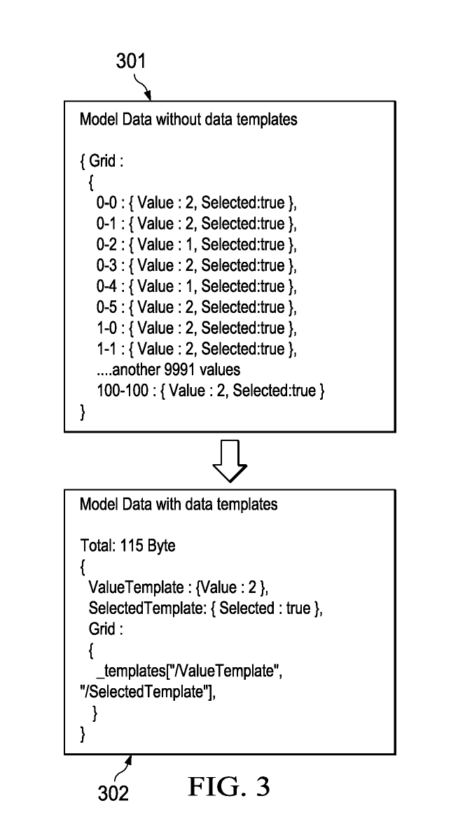

FIG. 3 illustrates a comparison of an exemplary update of an entire data grid without 301 and with 302 using the data template. As a default template is simply a special node in the Data structure it is possible to update the data for all data nodes by sending only an updated data template. Assume that you like to select all Data in the list. As the list might be very long normally an update to all items in the list needs to be done. The same effect may be achieved by updating the data template. In a general aspect, data cells may be appended or deleted by sending the updated data template.

The following code illustrates an comparison of an exemplary update of a range of a data grid by using the data template. For list and grid data it is also possible to define ranges that are used if the data is not available at the specialized data node. If data is available in the specialized node it will be taken from there. If no data is available in the range or specialized node the “_template” data will be used if available. In an implementation, the code may comprise one or more of the following steps:

```
{
  datagrid : {
    “0-0” : {property : “ItemX0Y0” },
    “0-1” : {property : “ItemX0Y1” },
    “1-0” : {property : “ItemX1Y0” },
    “1-1” : {property : “ItemX1Y1”, “selectable”: false },
    “__template” : {
      property: “GenerialItem”,
      selectable: true
      },
    “__ranges”: [
      {“[1,2]-[3,3]” : {
          property: “RangeItem”,
          selectable: true
        }},
      {“[4,*]-[5,*]” : {
          property: “RangeItem”,
          selectable: false
        }},
      ]
  }
}
Range Syntax for Grid Data:
Each item within the __ranges array can contain the following information:
“__ranges” : [
  {“[startX,startY]−[endX,endY]” : { }},
  {“[startX,*]−[endX,*]” : { }}, //for all in y positions startY to endY
  {“[*,startY]−[*,endY]” : { }}, //For all in y positions startY ro endY
//You can add ranges to a definition using +
  {“[startX1,startY1]−[endX1,endY1]+[startX2,startY2]−[endX2,endY2]” : { }}
Execution of Ranges
During runtime the ranges may be executed as they appear in the list. The first range that
serves a requested data may return it to the bound control.This may only be important if
overlapping ranges define the same properties but with different values. In this case the
first range may win.
Source Code (javascript)
/**
  * Returns the data node of the given path
  * @param {string} sPath the path to the object
  * @param {string} oContext the context of the path if relative
  * @param {boolean} bAvoidTemplated optional if templates should not be taken
into account
  * @returns the node of the specified path/context
  */
UCF_JSONModel.prototype._getObject = function(sPath, oContext,
bAvoidTemplated) {
    var oNode = this.isLegacySyntax( ) ? this.oData : null,
    // if path = null context must be respected as well: we handle this as
    // relative here
      sCurrentPath = “ ”,
      bIsRelative = sPath && UCF_StringUtil.bStartsWith(sPath, “/”) ?
false : true,
      aTemplateNodes = [ ],
      aContextNodes = [ ];
    if (bIsRelative && !oContext) {
      return null;
    }
    if (oContext instanceof UCF_BindingContext && bIsRelative) {
      sCurrentPath = oContext.getPath( );
      if (bAvoidTemplated) {
        oNode =
this._getObject(sCurrentPath,null,bAvoidTemplated);
      } else {
        oNode = this._getObjectContext(sCurrentPath);
      }
    } else if (oContext) {
      oNode = oContext;
    }
    if (!sPath) {
      return oNode;
    }
    var aParts = sPath.split(“/”),
      iIndex = 0;
    if (!aParts[0]) {
      // absolute path starting with slash
      oNode = this.oData;
      iIndex++;
    }
    if (UCF_JsUtil.bIsArray(oNode) && bIsRelative && !bAvoidTemplated) {
      var aContextNodes = oNode,
        iCurrentIndex = iIndex;
      for (var i=0;i<aContextNodes.length;i++) {
        oNode = aContextNodes[i];
        var iIndexTemplate = iCurrentIndex;
        while (oNode && aParts[iIndexTemplate]) {
          oNode = oNode[aParts[iIndexTemplate]];
          iIndexTemplate++;
        }
        if (oNode || typeof(oNode) ==“string” || typeof(oNode)
==“boolean” || typeof(oNode) ==“number” || typeof(oNode) ==“date”) {
          return oNode;
        }
      }
    }
    //search the node in the real path
    while (oNode && aParts[iIndex]) {
      sCurrentPath += “/”+ aParts[iIndex];
      oNode = oNode[aParts[iIndex]];
      iIndex++;
    }
    //if not found search also in the ranges and templates for absolute
paths
    if (aParts[iIndex-1] && !oNode && typeof(oNode) !=“string” &&
typeof(oNode) !=“boolean” && typeof(oNode) !=“number” && typeof(oNode)
!=“date” && !bAvoidTemplated) {
      if (sCurrentPath != “”) {
        var aContextNodes = this._getObjectContext(sCurrentPath);
        if (aContextNodes) {
          for (var i=0;i<aContextNodes.length;i++) {
            var oNode = aContextNodes[i][aParts[iIndex-
1]];
            if (oNode || typeof(oNode) ==“string” ||
typeof(oNode) == “boolean” || typeof(oNode) ==“number” || typeof(oNode)
==“date”) {
              return oNode;
            }
          }
        }
      }
    }
    return oNode;
};
/**
  * Returns all range objects that match the current path sPath. Ranges are
taken from the
  * given sRangePath
  *
  * @param {String} the path to match a range
  * @param {Object} the node of where the ranges are defined
  * @param {String} the path where the range is defined.
  *
  * @private
  */
UCF_JSONModel.prototype.getDataRangeObjects = function (sPath, oNode,
sRangePath) {
    var aNodes=[ ];
    if (oNode && oNode[“__ranges”]) {
      var aRanges = oNode[“__ranges”];
      if (!this.mRangeFunctions[sRangePath]) {
        if (typeof(aRanges) == “object” && !aRanges.length) {
          var iIndex = 0,
            aRangeArray = [ ];
          for (var n in aRanges) {
            aRangeArray[parseInt(n)] = aRanges[n];
          }
          aRanges =aRangeArray;
        }
        var aRangeFunctions = [ ];
        for (var i=0;i<aRanges.length;i++) {
          var oRangeDefinition = aRanges[i];
          if (!oRangeDefinition) continue;
          var fRangeFunction =
this. createRangeFunction(oRangeDefinition);
          if (fRangeFunction) {
            aRangeFunctions.push(fRangeFunction);
          }
        }
        this.mRangeFunctions[sRangePath] = aRangeFunctions;
      }
      var aRangeFunctions = this.mRangeFunctions[sRangePath];
      for (var i=0;i<aRangeFunctions.length;i++ ) {
        oNode = aRangeFunctions[i](sPath);
        if (oNode) {
          aNodes.push(oNode);
        }
      }
    }
    return aNodes;
};
/**
  * Creates the matching function for a range node
  *
  * @param {Object}the node that defines the range.
  */
UCF_JSONModel.prototype.createRangeFunction = function (oRangeDefinition) {
    var sMatchString = null,
      oRangeResultNode = null;
    for (var n in oRangeDefinition) {
      sMatchString = n;
      oRangeResultNode = oRangeDefinition[n];
      break;
    }
    //create a regular expression for the match string to check whether the
a target node is in the range or not
    var aParts = sMatchString.split(“+”),
      aFunctions = [ ];
    for (var i=0;i<aParts.length;i++) {
      var sPart = aParts[i],
        aTuples = [ ];
        //grid range
        if (sPart.indexOf(“−”)>−1) {
          //complex range [0,10]−[10,*] or 10−*
          aTuples = sPart.split(“−”);
        } else {
          aTuples = [sPart];
        }
        var func = (function (sMatchString, oRangeResultNode, aTuples) {
          var sEval = “”;
          if (sMatchString.indexOf(“]−[”)>−1) {
            for (var i=0;i<aTuples.length;i++) {
              aTuples[i] = aTuples[i].replace(“[”,“”);
              aTuples[i] = aTuples[i].replace(“]”,“”);
              var aValues = aTuples[i].split(“,”),
                sX = aValues[0],
                sY = aValues[1];
              if (i==0) {
                var aEvals = [ ];
                if (sX != “*”) {
                  aEvals.push(“ aNumbers[0] >= ” +
sX);
                }
                if (sY != “*”) {
                  aEvals.push(“ aNumbers[1] >= ”+
sY);
                }
                if (sY!=“*” || sX!= “*”) {
                  sEval += aEvals.join(“ && ”);
                }
              }
              if (i==1) {
                var aEvals = [ ];
                if (sX != “*”) {
                  aEvals.push(“ aNumbers[0] <= ” +
sX);
                }
                if (sY != “*”) {
                  aEvals.push(“ aNumbers[1] <= ” +
sY);
                }
                if (sY!=“*” || sX!=“*”) {
                  sEval += “ && ” + aEvals.join(“
&& ”);
                }
              }
            }
          } else {
            var aEvals = [ ],
              sX1 = aTuples[0],
              sX2 = aTuples[1];
            if (sX != “*”) {
              aEvals.push(“ aNumbers[0] >= ” + sX1);
            }
            if (sY != “*”) {
              aEvals.push(“ aNumbers[0] <= ” + sX2);
            }
            if (sY!=“*” || sX!=“*”) {
              sEval += aEvals.join(“ && ”);
            }
          }
          if (sEval === “”) sEval = “true”;
          var fMatch = new Function(“aNumbers”,“return ” + sEval),
            f = function (sPath) {
            var aNumbers = sPath.split(“−”);
            aNumbers[0] = parseInt(aNumbers[0]);
            aNumbers[1] = parseInt(aNumbers[1]);
            if (fMatch(aNumbers)) {
              return oRangeResultNode;
            }
            return null;
          };
          return f;
        })(sMatchString, oRangeResultNode, aTuples);
        aFunctions.push(func);
      }
      var combiningFunction = (function (aFunctions) {
        var f = function (sPath) {
          var sMatchPath =
sPath.substring(sPath.lastIndexOf(“/”)+1);
          for (var i=0;i<aFunctions.length;i++) {
            if (aFunctions[i](sMatchPath)) {
              return oRangeResultNode;
            }
          }
          return null;
        };
        return f;
      })(aFunctions);
      return combiningFunction;
};
/**
  * Returns a list of nodes that are used as a template for the given path.
  *
  * @param {string} sPath the path to the target node.
  * @param {object} oNode the node where the template is stored
  *
  * @returns {array} template nodes.
  *
  * @private
  */
UCF_JSONModel.prototype.getDataTemplateObjects = function (sPath, oNode,
bForceUpdate) {
    if (this.mDataTemplatesByDataPath[sPath] && !bForceUpdate) {
      return this.mDataTemplatesByDataPath[sPath];
    }
    var aTemplateData = [ ];
    if (oNode && oNode[“__templates”]) {
      var aTemplates = oNode[“__templates”];
      for (var i=0;i<aTemplates.length;i++) {
        var sTemplatePath = aTemplates[i],
          oTemplateNode =
this._getObject(sTemplatePath,null,true);
        if (oTemplateNode) {
          aTemplateData.push(oTemplateNode);
        }
        if (!this.mDataTemplates[sTemplatePath]) {
          this.mDataTemplates[sTemplatePath] = {
            node: oTemplateNode,
            paths:{ }
          };
        }
        if (!this.mDataTemplates[sTemplatePath].paths[sPath]) {
          this.mDataTemplates[sTemplatePath].paths[sPath] =
oNode;
        }
      }
    }
    if (aTemplateData.length > 0) {
      this.mDataTemplatesByDataPath[sPath] = aTemplateData;
    }
    return aTemplateData;
};
/**
  * Propagate all bindings to the data nodes that belong to templates that
changed
  */
UCF_JSONModel.prototype.checkTemplateUpdates = function( ) {
    for (var sPath in this.mDataTemplates) {
      var oNewNode = this._getObject(sPath),
        oOldNode = this.mDataTemplates[sPath].node;
      if (oNewNode != oOldNode) {
        var mDataNodePaths = this.mDataTemplates[sPath].paths;
        for (var sDataNodePath in mDataNodePaths) {
    this.getDataTemplateObjects(sDataNodePath,mDataNodePaths[sDataNodePath],
true);
        }
      }
    }
};
/**
  * Propagate all bindings to the data nodes that belong to a range that
changed
  */
UCF_JSONModel.prototype.checkRangeUpdates = function( ) {
    for (var n in this.mRangeFunctions) {
      delete this.mRangeFunctions[n];
    }
    this.mRangeFunctions = { };
};
```

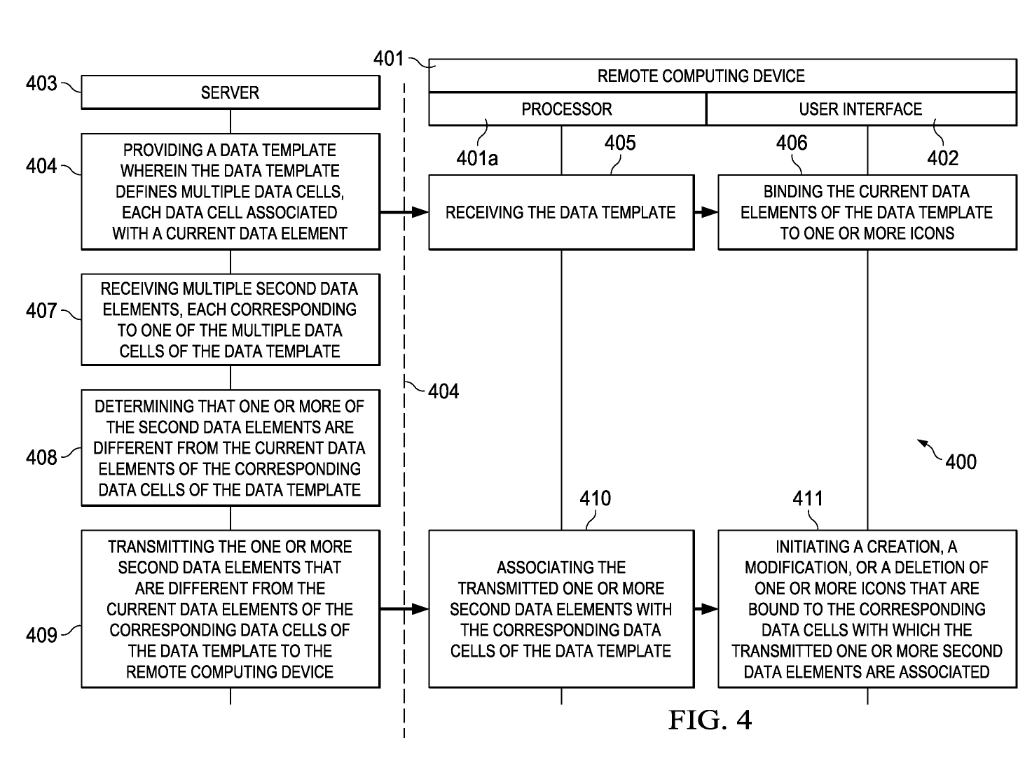

FIG. 4 illustrates an exemplary process or method 400 for updating a user interface 402 at a remote computing device 401. At 404, a data template is provided (e.g., across a wired or wireless network 404) by a server 403 to the remote computing device 401, wherein the data template defines multiple data cells that are configured to be bound to a user interface 402 at the remote computing device 401, and wherein each data cell is associated with a current data element. The user interface 402 may be a graphical user interface, such as a browser user interface, that comprises one or more icons that provide multiple functions, such as: input/out for parameter values, controlling (e.g., initiating, adjusting or ending) an electronic process inside or outside of the remote computing device (e.g., the icons 105 may control an electronic process at another computing device), sending or receiving emails or phone calls, or displaying measures such as a current status of the electronic process inside or outside the remote computing device. The current data elements may define control parameters of the one or more icons of the user interface 402, and wherein the control parameters are configured to create, launch, modify, update or delete corresponding one or more icons of the user interface 402. The remote computing device may comprise one or more processors 401a.

At 405, the remote computing device 401 receives the data template.

At 406, the remote computing device 401 binds the current data elements of the data template to one or more icons of the user interface 402.

At 407, the server 403 receives multiple second data elements each corresponding to one of the multiple data cells of the data template.

At 408, the server 403 determines that one or more of the second data elements are different from the current data elements of the corresponding data cells of the data template.

At 409, the server 403 transmits the one or more second data elements that are different from the current data elements of the corresponding data cells of the data template to the remote computing device 401. In an aspect, the one or more second data cells are transmitted to the remote computing device without transmitting to the remote computing device data elements of the multiple second data elements that are not different from the current data elements of the corresponding data cells of the data template.

At 410, the remote computing device 401 associates the transmitted one or more second data elements with the corresponding data cells of the data template, wherein the associating of the one or more second data elements with the corresponding data cells of the data template initiates, at step 411, a creation, a launch, a modification, an update or a deletion of one or more icons of the user interface 402 that are bound to the corresponding data cells with which the transmitted one or more second data elements are associated.

At a high level, computer or processor comprises an electronic computing unit (e.g., a processor) operable to receive, transmit, process, store, or manage data and information associated with an operating environment. As used in the present disclosure, the term “computer” or “processor” is intended to encompass any suitable processing device. The term “processor” is to be understood as being a single processor that is configured to perform operations as defined by one or more aspects described in this disclosure, or the “processor” comprises two or more processors, that are configured to perform the same operations, e.g. in a manner that the operations are distributed among the two or more processors. The processor may comprise multiple organic field-effect transistors or thin film transistors or a combination thereof. This may allow processing the operations in parallel by the two or more processors. The two or more processors may be arranged within a supercomputer, the supercomputer may comprise multiple cores allowing for parallel processing of the operations. For instance, computer or processor may be a desktop or a laptop computer, a cellular phone, a smartphone, a personal digital assistant, a tablet computer, an e-book reader or a mobile player of media. Furthermore, the operating environment can be implemented using any number of servers, as well as computers other than servers, including a server pool. Indeed, the computer or processor and the server may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the computer, processor and server may be adapted to execute any operating system, including Linux, UNIX, Windows, Mac OS, iOS, Android or any other suitable operating system.

The term “computing device”, “server” or “processor” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array), a CUDA (Compute Unified Device Architecture) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and operating environment can realize various different computing model infrastructures. In enterprise systems, there are OLTP (OnLine Transaction processing) systems used to carry out business processes of a company where employees and other stakeholders, such as suppliers or customers, follow a business process which may result in business documents created in a database of the OLTP system. In-memory databases thereby exploit recent innovations in hardware to run a database in main memory. The database system may be an in-memory database or a conventional database. For example, the server or the remote computing device may be an in-memory database or a conventional database. In an implementation of the present disclosure described herein, the server or the remote computing device may be types of a Java development platform, such as e.g., Enterprise JavaBeans® (EJB), J2EE Connector Architecture (JCA), Java Messaging Service (JMS), Java Naming and Directory Interface (JNDI), and Java Database Connectivity (JDBC), a ByDesing platform, Success Factors Platform, ERP Suite technology or in-memory database such as High Performance Analytic Appliance (HANA) platform. In an aspect, the server and the remote computing device may be based on two different of the above mentioned platforms.

Regardless of the particular implementation, “software” or “operations” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java, Visual Basic, assembler, Python and R, Perl, any suitable version of 4GL, as well as others.

The figures and accompanying description illustrate example processes and computer-implementable techniques. However, operating environment (or its software or hardware components) contemplates using, implementing, or executing any suitable technique for performing these and other processes. It will be understood that these processes are for illustration purposes only and that the described or similar techniques may be performed at any appropriate time, including concurrently, individually, or in combination. In addition, many of the steps in these processes may take place simultaneously, concurrently, and/or in different orders or combinations than shown. Moreover, operating environment may use processes with additional steps, fewer steps, and/or different steps, so long as the methods remain appropriate.

Aspects of the subject-matter and the operations described in this specification can be implemented in digital electronic circuitry, semiconductor circuits, analog circuits, or in computer software, firmware, or hardware, including the structures disclosed in this specification and their structural equivalents, or in combinations of one or more of them. Embodiments of the subject-matter described in this specification can be implemented as one or more computer programs, i.e., one or more modules of computer program instructions, encoded on computer storage medium for execution by, or to control the operation of a data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

A computer program (also known as a program, software, software application, script, or code) or “user interface” can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) “icons”, some or all associated with a web browser, such as interactive fields, pull-down lists, and buttons operable by the user of the computing device hosting the UI. These and other UI icons may be related to or represent the functions of the web browser. The term “browser user interface” refers to a graphical user interface embedded in a web browser environment on the remote computing device. The browser user interface may be configured to initiate a request for a uniform resource locator (URL) and may be configured to display a retrieved web page such as an HTML coded web page. The browser user interface may comprise displayed or hidden icons which, upon activation, initiate an associated electronic process inside or outside the remote computing device. For example, the browser user interface may be Internet Explorer, Chrome or Firefox. “Creating an icon” is to be understood as generating a new icon on the user interface. “Modifying an icon” is to be understood as changing a property of an existing icon on the user interface. “Deleting an icon” is to be understood as vanishing an existing icon on the user interface, e.g., for replacement by a newly created icon. “Updating the user interface” thereby is to be understood as creating, modifying, or deleting an icon on the user interface.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer or computer or processor may be a processor for performing actions in accordance with instructions and one or more memory devices for storing instructions and data. Generally, a computer or computer or processor will also include, or be operatively coupled to receive data from or transfer data to, or both, one or more mass storage devices for storing data, e.g., magnetic, magneto optical disks, or optical disks. However, a computer or computing device need not have such devices. Moreover, a computer or computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the user interface described in this specification can be implemented on a computer having a non-flexible or flexible screen, e.g., a CRT (cathode ray tube), LCD (liquid crystal display) or OLED (organic light emitting diode) monitor, for displaying information to the user and a keyboard and a pointer, e.g., a finger, a stylus, a mouse or a trackball, by which the user can provide input to the computer. Other kinds of devices can be used to provide for interaction with a user as well; for example, feedback provided to the user can be any form of sensory feedback, e.g., touch feedback, visual feedback, auditory feedback, or tactile feedback; and input from the user can be received in any form, including acoustic, speech, touch or tactile input. In addition, a computer or computer or processor can interact with a user by sending documents to and receiving documents from a device that is used by the user; for example, by sending web pages to a web browser on a user's user device in response to requests received from the web browser.

Implementations of the subject-matter described in this specification can be implemented in a computing system that includes a back end component, e.g., as a server, or that includes a middleware component, e.g., an application server, or that includes a front end component, e.g., a user computer having a graphical user interface or a Web browser through which a user can interact with an implementation of the subject-matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some implementations, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any implementation or on the scope of what may be claimed, but rather as descriptions of features that may be specific to particular implementations of particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the operations recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A system, comprising:
a processor;
a computer-readable storage medium coupled to the processor having instructions stored thereon which, when executed by the processor, cause the processor to perform operations comprising:
providing a data template to a remote computing device, wherein the data template defines multiple data cells that are bound to a graphical user interface at the remote computing device, and wherein each data cell is associated with a current data element;
receiving multiple second data elements each corresponding to one of the multiple data cells of the data template;
determining that one or more of the second data elements are different from the current data elements of the corresponding data cells of the data template;
transmitting the one or more second data elements that are different from the current data elements of the corresponding data cells of the data template to the remote computing device for associating the transmitted one or more second data elements with the corresponding data cells of the data template.

2. The system of claim 1, wherein the one or more second data cells are transmitted to the computing device without transmitting to the computing device data elements of the multiple second data elements that are not different from the current data elements of the corresponding data cells of the data template.

3. The system of claim 1, wherein the associating of the transmitted one or more second data elements with the corresponding data cells of the data template comprises:
binding the transmitted one or more second data elements to the graphical user interface; and
updating the graphical user interface.

4. The system of claim 1, wherein the graphical user interface is a browser user interface.

5. The system of claim 1, wherein the data template is a table comprising the multiple data cells and their associated data elements, or wherein the data elements are stored in the associated data cells of the data template.

6. The system of claim 1, wherein the data elements define control parameters of icons of the graphical user interface, wherein the control parameters are configured to create, modify, or delete corresponding one or more icons of the graphical user interface.

7. The system of claim 6, wherein the associating of the one or more second data elements with the corresponding data cells of the data template initiates a creation, a modification, or a deletion of the one or more icons of the graphical user interface that are bound to the corresponding data cells with which the transmitted one or more second data elements are associated.

8. A computing device, comprising:
a processor;
a computer-readable storage medium coupled to the processor having instructions stored thereon which, when executed by the processor, cause the processor to perform operations comprising:
receiving a data template from a remote server, wherein the data template defines multiple data cells that are bound to a graphical user interface at the computing device, and wherein each data cell is associated with a current data element;
receiving, from the remote server, one or more second data elements that are different from the current data elements of the corresponding data cells of the data template; and
associating the transmitted one or more second data elements with the corresponding data cells of the data template, wherein the associating of the one or more second data elements with the corresponding data cells of the data template initiates a creation, a modification, or a deletion of one or more icons of the graphical user interface that are bound to the corresponding data cells with which the transmitted one or more second data elements are associated.

9. The device of claim 8, wherein the one or more second data cells are transmitted from the remote server to the computing device without transmitting to the computing device data elements of the multiple second data elements that are not different from the current data elements of the corresponding data cells of the data template.

10. The device of claim 1, wherein the associating of the transmitted one or more second data elements with the corresponding data cells of the data template comprises:
binding the transmitted one or more second data elements to the one or more icons of the graphical user interface; and
updating the graphical user interface.

11. The device of claim 8, wherein the data template is a table comprising the multiple data cells and their associated data elements, and wherein the data elements are stored in the associated data cells of the data template.

12. The device of claim 8, wherein the data elements define control parameters of one or more icons of the graphical user interface, wherein the control parameters are configured to create, modify, or delete corresponding one or more icons of the graphical user interface.

13. A method implemented in a server, the method comprising:
providing a data template to a remote computing device, wherein the data template defines multiple data cells that are bound to a graphical user interface at the remote computing device, and wherein each data cell is associated with a current data element;
receiving multiple second data elements each corresponding to one of the multiple data cells of the data template;
determining that one or more of the second data elements are different from the current data elements of the corresponding data cells of the data template; and
transmitting the one or more second data elements that are different from the current data elements of the corresponding data cells of the data template to the remote computing device for associating the transmitted one or more second data elements with the corresponding data cells of the data template.

14. The method of claim 13, wherein the one or more second data cells are transmitted to the computing device without transmitting to the computing device data elements of the multiple second data elements that are not different from the current data elements of the corresponding data cells of the data template.

15. The method of claim 13, wherein the associating of the transmitted one or more second data elements with the corresponding data cells of the data template comprises:
binding the transmitted one or more second data elements to the graphical user interface; and
updating the graphical user interface.

16. The method of claim 13, wherein the data template is a table comprising the multiple data cells and their associated data elements, and wherein the data elements are stored in the associated data cells of the data template.

17. The method of claim 13, wherein the data elements define control parameters of icons of the graphical user interface, wherein the control parameters are configured to create, modify, or delete corresponding one or more icons of the graphical user interface.

18. The method of claim 17, wherein the associating of the one or more second data elements with the corresponding data cells of the data template initiates a creation, a modification, or a deletion of the one or more icons of the graphical user interface that are bound to the corresponding data cells with which the transmitted one or more second data elements are associated.

19. A computer-readable medium having computer-executable instructions stored thereon that, when executed by a processor, cause the processor to perform the operations of claim 13.

20. A system for updating a graphical user interface on a remote computing device, the system comprising:
a server, comprising:
a first processor;
a computer-readable storage medium coupled to the processor having instructions stored thereon which, when executed by the first processor, cause the first processor to perform operations comprising:
providing a data template to the remote computing device, wherein the data template defines multiple data cells that are configured to be bound to a graphical user interface at the remote computing device, and wherein each data cell is associated with a current data element;
receiving multiple second data elements each corresponding to one of the multiple data cells of the data template;
determining that one or more of the second data elements are different from the current data elements of the corresponding data cells of the data template; and
transmitting the one or more second data elements that are different from the current data elements of the corresponding data cells of the data template to the remote computing device; and
the remote computing device, comprising:
a second processor;
a computer-readable storage medium coupled to the processor having instructions stored thereon which, when executed by the second processor, cause the second processor to perform operations comprising:
receiving the data template and binding the current data elements to one or more icons of the graphical user interface at the remote computing device, wherein the current data elements define control parameters of the one or more icons of the graphical user interface, and wherein the control parameters are configured to create, modify, or delete corresponding one or more icons of the graphical user interface;
associating the transmitted one or more second data elements with the corresponding data cells of the data template, wherein the associating of the one or more second data elements with the corresponding data cells of the data template initiates a creation, a modification, or a deletion of one or more icons of the graphical user interface that are bound to the corresponding data cells with which the transmitted one or more second data elements are associated.

21. The system of claim 20, wherein the one or more second data cells are transmitted to the remote computing device without transmitting to the remote computing device data elements of the multiple second data elements that are not different from the current data elements of the corresponding data cells of the data template.
